(19) United States
(12) Patent Application Publication
(10) Pub. No.: US 2009/0188693 A1
(43) Pub. Date: Jul. 30, 2009

(54) Electrical-Outlet Faceplate with Hinged Cover Doors

(76) Inventor: Evester Noble Simmons, St. Louis, MO (US)

Correspondence Address: Evester N. Simmons, 2242 New Sun Drive, Florissant, MO, 63031, US

(21) Appl. No.: 12/021,986

(22) Filed: Jan. 29, 2008

(51) Int. Cl. H02G 3/14

(52) U.S. Cl. 174/67

(57) ABSTRACT

A childproof electrical outlet faceplate with hinged cover doors includes a rectangular frame for covering an electrical outlet with a pair of sockets. The frame has an opening in its center through which a screw is extended to attach the faceplate to the outlet. The faceplate is similar in size to a standard faceplate and is installed in place of it and includes two hinged cover doors fitting over the respective sockets. These cover doors are opened and closed by means of a spring activated locking bar. The faceplate also has a disguised flip door located at the right side bottom of the faceplate. When the flip door is open it gives access to a dummy spring button which, when pushed, does not open the cover doors. Rather, there is another upward spring button which, when pushed by someone's finger, moves a vertically moving slide that catches and releases hooks for the hinged cover doors from a locking bar.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

The present invention relates generally to electrical wall outlets; and, more particularly, to faceplates fitting over the outlets, the faceplates having hinged cover doors for covering the outlets.

Electrical outlets seem to be particularly irresistible to children. They seem to derive great enjoyment from inserting various objects into the outlets, such as spoons, forks, knives, toys, nails, pins or just about any other item they may get their hands on. Of course, with the insertion of conductive items into the receptacle, the potential for receiving an electrical shock exists. In the case of children, the danger of suffering (or even being killed) from the electrical shock is greater because of their small bodies as compared to adult's bodies.

There have been various sorts of covers and shields proposed to reduce the threat of electrocution of children. The most common covers are made from plastic, have two prongs for insertion into the outlet openings, and are held in place by friction. Other covers have hinged doors that are held against outlet openings by springs. Unfortunately, curious children can pull the known covers open with a tug.

### BRIEF SUMMARY OF THE INVENTION

In respect of the known problems associated with the present covers for electrical outlets, it is a principal object of my invention to provide a faceplate with covered hinged doors, that minimizes the likelihood of electrical shock or electrocution from the electrical outlets to which electrical devices may or may not be connected. The faceplate with hinged cover doors is screwed into the wall of an electrical outlet and prevents the insertion of foreign objects into outlet openings by children/toddlers. The outlet openings are selectively covered by doors that are locked closed when access to the outlet openings are not required. A hidden button in the faceplate on which the hinged cover doors are mounted provides access to release the locked doors.

It is another object of the invention to provide a faceplate with hinged cover doors of the type described that can be easily installed without resort to any tools other than a screwdriver. After installation, the covered hinged faceplate can be used with minimal training.

It is an object of the invention to provide improved features and arrangements thereof in an electrical outlet covered hinged faceplate for the purposes described that is aesthetically pleasing, lightweight in construction, inexpensive to manufacture, and dependable in use. The hinged covered faceplate with the cover doors will completely cover both outlets and will allow adult access to them without the need to remove the device completely. The unique spring-loaded closure of the hinged cover doors on this replacement plate will aid parents with its convenient use. After installation, one will not have to worry about the cover hinged doors wearing out, or misplacing or forgetting to replace an outlet cover.

A primary application of my faceplate with hinged cover doors is residences where young children reside. In other instances, homeowners may install it as a safeguard to protect children who may visit from time to time, or as a means to upgrade the safety conditions of their home. The safety and design features of the faceplate with hinged cover doors, while ideal for homes where children reside, could also benefit businesses that cater to families. In both homes and businesses, the faceplate with hinged cover doors could reduce insurance liability by minimizing the potential for accidents.

The foregoing and other objects, features, and advantages of the present invention will become readily apparent upon further review of the following detailed description of my faceplate with hinged cover doors as illustrated in the accompanying drawings.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a perspective view of a universal electrical outlet faceplate of the present invention having hinged cover doors which are shown in their closed positions;

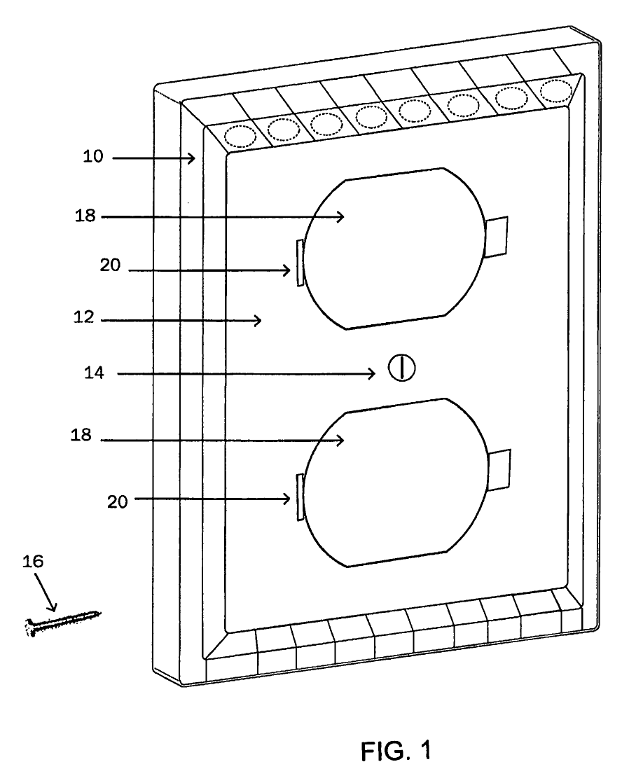

FIG. 2 is view similar to FIG. 1 with the hinged cover doors opened and illustrating the mechanism by which the hinged cover doors are held in their closed positions and released to open;

FIG. 3 is side, sectional view of the faceplate with the hinged cover doors in their closed position and illustrating how the mechanism maintains the doors closed; and,

FIGS. 4A and 4B are two views of an internal spring with FIG. 4A showing top and bottom slide bars that snaps together with an internal spring activated locking bar and a pair of clamps mounted to a rectangular frame with an internal hidden button, and FIG. 4B showing catchers that allow J shaped hooks to lock.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

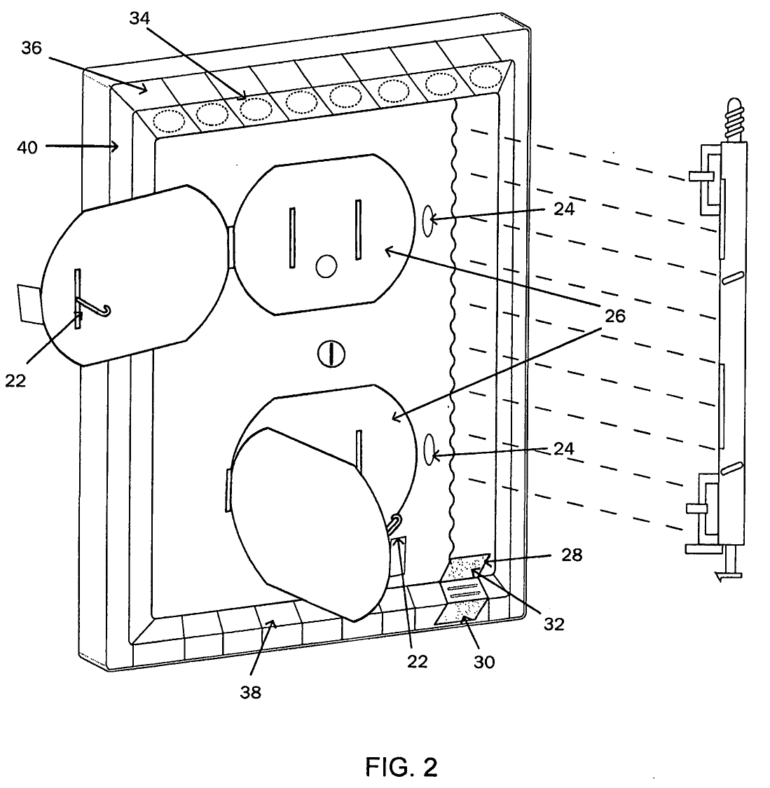

Referring to the drawings, an electrical outlet cover faceplate of the present invention with hinged cover doors, and which is installed instead of a conventional faceplate, is indicated generally 10. Faceplate 10 includes a rectangular frame 12 having a center hole 14. A screw 16 screws in through center hole 14 to installs faceplate 10 in place. The faceplate further includes a pair of hinged cover doors 18, on door being a top or upper hinged door, and the other a bottom or lower hinged door. Each hinged cover door 18 is mounted to faceplate 10 by hinge rod 20 which allows the hinged cover door 18 to swing open and closed. When closed or shut, the cover door is locked in place. A J shaped hook 22 (see FIG. 2) is attached to each hinged cover door. The curved end of each hook fits through a respective slot 24 formed in the outer surface of faceplate 10, when the respective doors 18 are closed. The hinged cover doors 18 are molded from a plastic or other suitable material with the J shaped hooks 22 being molded to the inside of the doors. The swing hinged rods 20 are also molded together with the hinged cover doors 18.

Frame 12 of faceplate 10 is preferably molded as a single piece of plastic or other suitable material and includes a rectangular front wall 34 from the top of which a top wall 36 angles or extends rearwardly, and from the bottom of which a bottom wall 38 also angles or extends rearwardly. Opposed sidewalls 40 angle or extend rearwardly from front wall 34 of the faceplate. When in place, faceplate 10 fits over a pair of electrical outlets or sockets 26 of conventional construction. When closed, the hinged cover doors 18 cover or shield the sockets. Because the hinged cover doors are locked in place, a child cannot now insert a finger or object into the socket and suffer an electrical shock. Front wall 34 is designed to camouflage sections 28 and 30 of door 27. A square shaped box portion of top wall 34 can be molded from a clear plastic material so a night light can be installed.

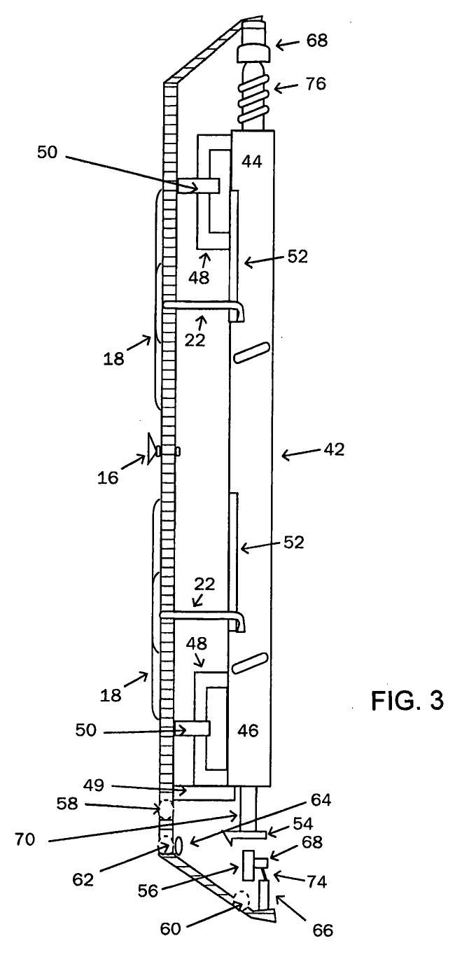

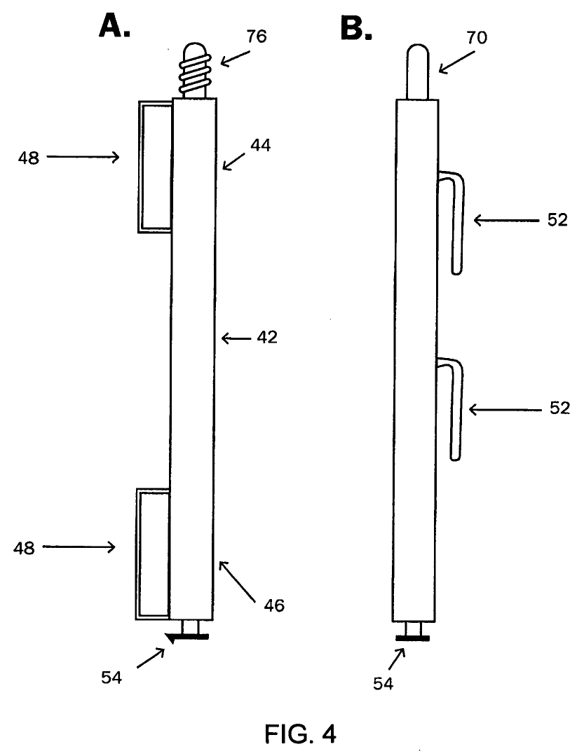

Also shown in FIG. 2 is a two-part flip door 27 that includes a top or upper flip section 28 that flips upwardly, and a bottom or lower flip section 30 which flips downwardly. Swing hinged rods (not shown) are molded to the respective door sections 28 and 30. When these door sections are opened, they expose a finger lift 32 that is installed inside frame 12 of faceplate 10 and which is part of a mechanism used in releasing the hinged cover doors so they can open. An internal spring activated body 42 (see FIG. 4A) has a top part 44 and a bottom part 46. Slide bars 48 are respectively attached to body 42 at the top and bottom thereof. The slide bars 48 are engaged by respective clamps 50 which extend inwardly from an inner surface of faceplate 10 and which accommodate reciprocal vertical movement of the spring body. Also attached to body 42 is a pair of top and bottom catchers 52. The catchers, which have an inverted L-shape so to be open at their bottom, are circumferentially spaced from the slide bars about the spring activated body. When the mechanism is in its position shown in FIG. 3, the vertical arm of each catcher engages the inner, curved end of a J hook 22, preventing movement of the hook, and locking its associated hinged cover door 18 in its closed position.

Body 42, slide bars 48, and the catchers 52 are molded together in a single piece construction from plastic or another suitable material in the same mold. The molded piece has a center bore that allows body 42 to be fitted onto a rod 70 that has a push button 54 at its lower end. A bias spring 76 is sized to fit over the upper end of the rod. The lower end of the spring seats against the top of body 42, while the other end of the spring bears against a projection 68 to bias the mechanism to its position shown in FIG. 3. The clamps 50 are also molded from plastic or other suitable material and are affixed to the inside of frame 12. As shown in FIG. 3, one clamp is located adjacent top hinged cover door 18 and the other clamp is located adjacent the bottom hinged cover door 18.

The base of lower side bar 48 rests upon a ledge 49 which extends inwardly from the inner face of frame 12. At the base of spring body 42 is a push button 54. This push button is located behind upper section 28 of two-part door 27 so to normally be hidden from view when the door is closed. As noted, finger lift 32 is used to open door section 28. Pushing up on finger lift 32 unsnaps a clamp 62 from a clamp catcher 64. Opening door section 28 also exposes a dummy button 56. When someone pushes inwardly on button 56, nothing happens because this push button is not connected to the release mechanism that allows hinged cover doors 18 to be opened.

To release the hinged cover doors, one pushes on the button 54 at the base of rod 70 to lift the rod on spring body 42. This vertical movement is guided by the side bars 48 sliding through the clamps 50. At the same time, vertical movement of the catchers 52 releases the curved, inner end of each J hook 22 so it can move through its associated slot 24 and expose an electrical socket 26. When finger pressure is removed from push button 54, spring 76 urges the mechanism downwardly and back to its locked position. It will be understood by those skilled in the art that either hook can be selectively released so only one hinged cover will be open and expose its associated socket, or both hooks can be released together so both hinged covers can be opened and theit associated outlets exposed.

When it is no longer necessary to use the electrical outlet, the above procedure is repeated except that now when the mechanism is raised, the hinged cover doors are closed by re-inserting the curved end of the J hook backs through its slot 24. Then, when push button 54 is released and spring 76 urges the mechanism downwardly, the vertical arm of catcher 52 while slide over the curved inner end of the hook, locking it in place and the hinged cover door in its closed position. At the end of each operation, pushing up on door section 30, and pushing down on door section 28, causes clamp 62 to snap back together with clamp catcher 64 and locks door 27 closed.

As described herein, a first object of the invention is achieved by providing a childproof faceplate cover with hinged locked doors to replace a standard, conventional faceplate to enclose electrical sockets. The faceplate of the invention fulfills the need for increasing the safety of children by preventing them from tampering with electrical outlets.

A second object of the invention is achieved by providing a universal, childproof faceplate in a configuration that accommodates a wide range of standard electrical outlet sockets. This eliminates the need for special devices to prevent electrical shock or electrocution from electrical outlets to which electrical devices may or may not be connected. The advantageous feature of the hinged cover doors are the safety, security, convenience, and the peace of mind the device provides for parents of young children. The faceplate aids in preventing electrical shock to individuals, most notably children, by preventing tampering with an electrical outlet. The electrical outlet faceplate with hinged cover doors provides covering doors for both outlets on the faceplate. Parents will enjoy peace of mind knowing that children cannot gain access to the sockets, which could result in a potentially serious shock to the child.

A third object of the invention is achieved in that the faceplate is easy to install, is simple to use, and reasonably priced. Because the electrical outlet faceplate with hinged cover doors of the invention is installed as a replacement for the standard faceplate and remains in place when only one outlet is needed, there is little or no chance of a parent misplacing or forgetting to replace an outlet cover. Also, with frequent removal and replacement, standard outlet covers tend to wear out. The electrical outlet faceplate with hinged cover doors does not wear out, even with frequent use. As such, it offers a convenient, inexpensive and efficient means of upgrading the safety standards of electrical outlets in the home, office, or school.

Although there has been shown and described an example of what is at present considered the preferred embodiment of the present invention, it will be obvious to those skilled in the art that various changes and modifications may be made therein without departing from the scope of the invention as defined by the appended claims.

Having thus described the invention, what is claimed and desired to be secured by Letters Patent is:

1. A faceplate fitting over at least one electrical outlet comprising:
a hinged cover which can be selectively opened and closed to expose the outlet, the cover including a hook and the faceplate having an opening through which one end of the hook is inserted; and,
a mechanism for capturing the one end of the hook and holding it in place so the hinged cover cannot be opened and the outlet exposed, the mechanism being a movable mechanism which, when moved, releases the one end of the hook and allows the cover to open and expose the outlet.

2. The faceplate of claim 1 fitting over two electrical outlets and including a separate hinged cover for each outlet, each cover including a hook and the faceplate having a separate opening through which one end of each hook is inserted.

3. The faceplate of claim 2 in the mechanism captures the one end of each hook and holds it in place so the hinged cover cannot be opened and the outlet exposed, the mechanism, when moved, allowing the one end of each hook to be selectively released to allow the respective cover to open and expose its associated outlet.

4. The faceplate of claim 3 including a vertically movable post including a pair of spaced catchers each of which releasably engages the one end of one of the hooks so to hold the hinged covers closed when the mechanism is in one position, but to release the hook when the mechanism is moved to another position so the hinged covers can be opened.

5. The faceplate of claim 4 in which the mechanism includes a slidable bar attached to the post and the faceplate includes a clamp through which the bar moves when the post is moved, so to guide movement of the post.

6. The faceplate of claim 5 in which the post includes a push button at one end for pushing the post in a direction to release the one end of each hook, and a spring at the other end of the post for biasing the post toward its position in which the one end of the hooks are engaged by the catchers.

7. The faceplate of claim 1 further including an access door for accessing the mechanism.

8. The faceplate of claim 7 further including a push button hidden behind the door which, when pushed, does nothing to operate the mechanism.

9. The faceplate of claim 1 in which the hook is a J hook the curved end of which fits through the slot in the faceplate.

10. The faceplate of claim 1 further including a night light.
